(19) United States
(12) Patent Application Publication
(10) Pub. No.: US 2006/0245891 A1
(43) Pub. Date: Nov. 2, 2006

(54) Removably attachable forklift for light truck applications

(76) Inventor: Michael T. Flaherty, Holliston, MA (US)

Correspondence Address: Robert K. Tendler, 65 Atlantic Avenue, Boston, MA, 02110, US

(21) Appl. No.: 11/118,717

(22) Filed: Apr. 29, 2005

(51) Int. Cl. B66F 9/18

(52) U.S. Cl. 414/607

(57) ABSTRACT

A releasably detachable forklift assembly is coupled to a snowplow mount on a light truck to utilize the mechanical actuating features of the snowplow assembly to actuate the forklift assembly for lifting the forklift and angling it. The use of the light truck provides for forklift transport, adequate clearance for uneven terrain, and with the height of the seat of the light truck affording excellent visibility above the load carried by the tines of the forklift assembly.

### FIELD OF THE INVENTION

This invention relates to forklifts and more particularly to a forklift assembly removably attachable to a snowplow mount.

### BACKGROUND OF THE INVENTION

Forklift trucks are exceedingly common for materials handling in which heavy loads such as pallets are moveable from one location to another through the insertion of the tines of a forklift underneath the pallet and the raising of the pallet on an elevator assembly at the front of a small, specially adapted vehicle. The vehicles themselves are designed to run on flat floors and to move pallets from one warehouse position to another by running over the smooth floor. While relatively small, these forklift trucks are not affordable to a wide variety of contractors and must be transported to a worksite, for instance by using flatbed trucks.

Thus, when bidding on a construction job, contractors very often will decline to bid due to the inability to move heavy loads at a worksite. The primary reason for their inability to bid is the fact that the traditional forklift truck is either incapable of moving over uneven terrain or is not designed to be moved to the jobsite by other than a flatbed truck.

Moreover, if the traditional forklift truck were to be positioned at a jobsite where there is uneven terrain, there is usually not enough clearance underneath the forklift truck to work on anything but flat pavement or flooring, making the use of the traditional forklift undesirable for remote jobsite use.

It will be appreciated, for instance, that gardeners and other landscape contractors must oftentimes transport trees and other large bushes by first trucking the trees to the jobsite at one point where there is access to the jobsite and then either dragging the tree or bush over the ground, picking it up manually or providing it with skids so as to be able to position the tree or large bush for planting. Under such circumstances forklift trucks would not be appropriate due to the uneven terrain over which the tree or bush most travel from the place where it is dropped off at the edge of the jobsite to the place where it is to be planted.

Moreover, for curbing and sidewalk contractors it is oftentimes necessary to transport heavy, cumbersome granite slabs from a place where they are deposited, again at the entrance to the jobsite to a position well within the jobsite where the slabs are to be laid out. Additionally, general building contractors, especially bricklayers, stonemasons, roofing contractors, ironworkers and carpenters who must transport heavy materials from the jobsite entrance to the place at which they are to be used.

As will be appreciated, on jobsites it is oftentimes necessary to transport barrels of material such as fuel, chemicals, paints and finishes or other materials where these items again are dropped off to another location on the jobsite.

The way that contractors attempt to handle such problems is through the use of manual labor or skids or other towing devices; or the contractor merely does not bid the job because he does not have the equipment to be able to do these short distance transport operations.

Thus there is a need to provide adequate short distance transport of heavy items, including pallets and the like, over uneven terrain.

### SUMMARY OF INVENTION

Rather than transporting the traditional forklift to the jobsite and rather than having to determine how the traditional forklift can traverse uneven terrain, in the subject invention the ubiquitous pickup truck with snowplow attachment is provided with a releasably detachable forklift assembly that is moved up and down by virtue of the same mechanism that moves the plow blade up and down.

In one embodiment the tines of the forklift are made to pivot on a vertical axis by the snowplow actuators so as to provide increased positioning flexibility. In an additional embodiment the normal backwardly-sloping tines when lifted can be corrected to a horizontal position by an actuator so as to adjust the leveling of the tines of the forklift assembly as the assembly is lifted upwardly and tilted back.

The assembly in one embodiment is open at the top to permit a person in the truck cab to see over and above the load due to his high perch and open forklift, unlike traditional forklift trucks that block the operator's sight line due to the carriage rack normally used.

Most importantly, when mounted on a four wheel drive pickup truck, the forklift assembly is transportable to the jobsite over the normal highway infrastructure and then over the uneven terrain of the jobsite due to the clearance of the undercarriage of the pickup truck and due to its four-wheel drive.

The forklift assembly is releasably attachable to the snowplow mount after the snowplow has been detached by mounting the forklift assembly in the same way as the snowplow is coupled to the snowplow mount. This involves the insertion of three pins two laterally to either side of the mount to accommodate the snowplow positioning actuators normally used to angle the plow blade, and one in the center to permit lateral pivoting.

The result of this type of mounting is that, unlike traditional forklift trucks, the forklift tines of the truck may be angled with respect to the center line of the pickup truck so that the tines may be able to be maneuvered at the point at which they are to be inserted underneath the load.

It will be appreciated that, rather than having an elevator that moves the forklift on a forklift truck, in the subject invention the forklift is upwardly moved by the same type of pivoting action that picks up the snowplow. Thus the load is lifted by virtue of the pivoting of the forklift attachment upwardly through a chain drive or other actuator, with the forklift assembly pivoted upwardly from a lateral pivot for the frame normally used in the snowplow mount.

Moreover, in one embodiment, as the forklift assembly is hoisted up by the chain drive or other actuator, the tines tilt backwardly so that the load is moved against a backing member of the assembly for safety purposes.

In a still further embodiment, upon raising of the forklift assembly, the tines are rotated downwardly as the assembly is pivoted upwardly so as to level the tines as they are lifted.

The result is that one can use existing snowplow mounts attached to small trucks to give contractors the ability to bid jobs that they heretofore have not been able to bid. The clearance of the pickup truck accommodates uneven terrain and the forklift is transportable to the jobsite by simply driving the truck over the highway. Thus, in order to provide forklift functionality, one need not separately transport a traditional forklift truck to the jobsite. Rather, one can use one's pickup truck with snowplow mount and simply fit it with forklift tines hung on a frame attached to the mount.

The subject forklift attachment for snowplow mounts thus uses the inherent capabilities of the snowplow mount and the pickup truck that include lifting a blade corresponding to lifting of the forklift tines; pivoting of the blade, which corresponds to the pivoting of the forklift tines; and transport of the entire apparatus due to the fact that it is mounted on a light truck.

Moreover, when attached to a light truck, any counterbalancing that needs to be provided may be provided by adding weights to the bed of the pickup truck so that the pickup truck will not tilt forward when picking up heavy loads,

In summary, a releasably detachable forklift assembly is coupled to a snowplow mount on a light truck to utilize the mechanical actuating features of the snowplow assembly to actuate the forklift assembly for lifting the forklift and angling it. The use of the light truck provides for forklift transport, adequate clearance for uneven terrain, and with the height of the seat of the light truck affording excellent visibility above the load carried by the tines of the forklift assembly.

### BRIEF DESCRIPTION OF THE DRAWINGS

These and other features of the subject invention will be better understood in connection with a Detailed Description, in conjunction with the Drawings, of which:

FIG. 1 is a diagrammatic illustration of a traditional forklift truck on the floor of a warehouse or adjacent parking lot;

FIG. 2 is a diagrammatic illustration of the attempted use of the forklift truck of FIG. 1 on uneven terrain, indicating the unsuitability thereof;

FIG. 3 is perspective view of the attachment of the subject forklift assembly on a snowplow mount carried by a pickup truck, showing the ability to transport a heavy load over uneven terrain;

FIG. 4 is a side view of the forklift assembly coupled to the snowplow mount of a pickup truck, illustrating the visibility from the cab of the pickup truck such that the operator of the forklift assembly is not impaired by having to look around the elevator-driven carriage rack used by traditional forklift trucks;

FIG. 5 is an exploded view of the subject forklift assembly in front of the snowplow mount to which it is to be attached, illustrating the lateral actuators for the snowplow and the central pivot point that permits angling of the forklift assembly with respect to the center line of the pickup truck to which it is attached;

FIG. 6 is a top view of the forklift assembly attached to a snowplow mount, illustrating the actuators and pivot point for angling the forklift attachment;

FIG. 7 is a top view and diagrammatic illustration of the forklift assembly and snowplow mount of FIG. 6, illustrating the angling of the forklift tines using the snowplow mount actuators;

FIG. 8 is a side view of the lifting of the forklift assembly of FIG. 3 by virtue of raising the snowplow mount that results in the angling back of the tines of the forklift assembly, illustrating the horizontal repositioning of the tines of the forklift assembly as the snowplow assembly is raised to lift the forklift assembly;

FIG. 9 is a side view of the final position of the forklift of FIG. 8, illustrating the horizontal relationship of the tines to the ground;

FIG. 10 is a diagrammatic illustration of the removal of a snowplow blade from a snowplow mount that is mounted to the front portion of a light truck, illustrating removal of three pins for the removal of the blade;

FIG. 11 is a diagrammatic illustration of the positioning of the subject forklift assembly on the ground adjacent the front portion of the snowplow mount for mounting the forklift assembly to the snowplow mount; and,

FIG. 12 is a diagrammatic illustration of the movement of the snowplow mount into engagement with the forklift assembly and the placement of the pins to releasably attach the forklift assembly to the front end of the snowplow mount.

### DETAILED DESCRIPTION

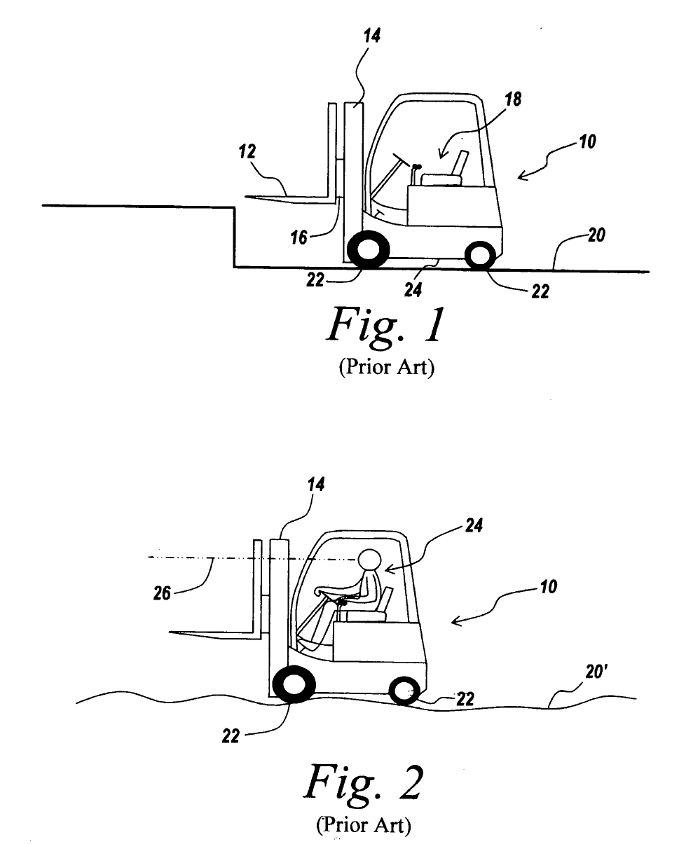

Referring now to FIG. 1, in the prior art, a traditional forklift truck 10 is provided with a forklift assembly 12 attached to a forward member 14 of the forklift through an elevator 16, such that the tines of the forklift may be raised by an operator seated at position 18.

As illustrated, forklift truck 10 is adapted to move along a flat surface 20. The wheels 22 normally used by a forklift truck are relatively small and provide virtually no clearance between the bottom 24 of the truck and the ground or floor.

As illustrated in FIG. 2, when forklift truck 10 is to be deployed over uneven terrain 20′, there is insufficient clearance. Moreover, since the traditional forklift trucks are not adapted to traverse a highway, they must be transported by other means, such as flatbed truck, to a jobsite.

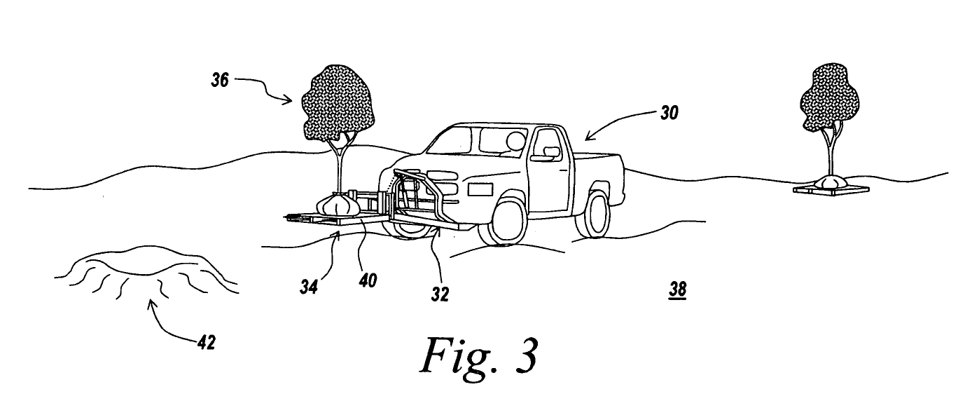

In order to provide for a forklift operation at a remote jobsite and referring now to FIG. 3, a light truck 30, such as a pickup truck, that carries a snowplow mount 32 is provided with a releasably attachable forklift assembly 34 used in place of the normal snowplow blade.

Because the forklift assembly is attached to the snowplow mount in the same way as the snowplow blade, the forklift assembly can be maneuvered identically to the snowplow blade so as to be able to position the tines of the forklift assembly by raising and lowering them and by angling them from side to side. The result at a jobsite 36 is that the truck can be driven over the uneven terrain at the jobsite due to the fact that the pickup truck has sufficient clearance and may be a four wheel drive vehicle. Moreover, because the forklift assembly need not be a part of a forklift truck that has to be separately transported to the jobsite by another vehicle, the entire apparatus may be transported by the same truck used to transport workers to the jobsite by another vehicle.

In the illustrated application, a heavy tree 36 is located on a pallet 40 picked up by the tines of the forklift assembly 34. The truck is maneuvered under its own power to a position 42 over terrain 38 where the load is to be deposited,. What will be immediately appreciated is that the forklift assembly, which may be carried in the truck bed of the truck, is transported from wherever the truck is normally parked to the jobsite and then onto the jobsite, where it can be used for lifting unwieldy or heavy loads and transporting them a short distance to the point at which a load is to be deposited.

In view of the ubiquitous nature of pickup trucks and snowplow attachments, the subject releasably attachable forklift assembly provides instant access for contractors to contracts that they would ordinarily be unable to bid on due to the inability, either financial or physical, to provide a forklift function at a jobsite.

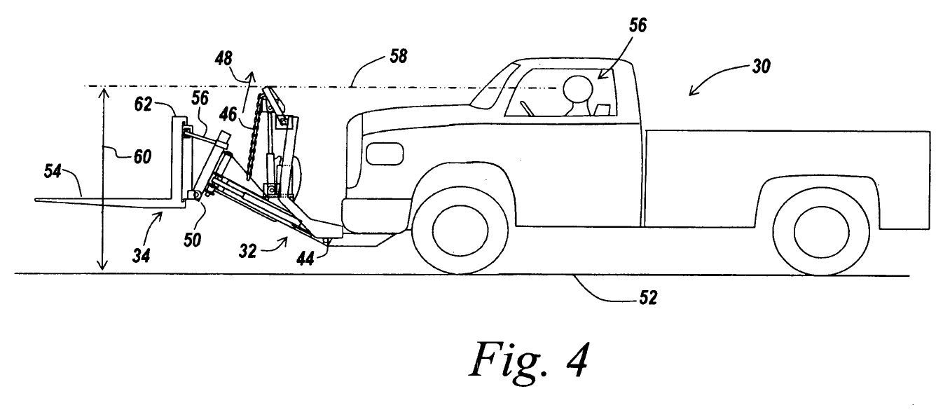

Referring now to FIG. 4, pickup truck 30 is illustrated as having the snowplow mount 32 hingedly attached to the forward end of the truck at lateral pin 44, such that when actuator or chain 46 moves in the direction of arrow 48, the forward edge 50 of the snowplow mount is raised.

Upon raising the forward edge of snowplow mount 32 by virtue of its pivot about pin 44, forklift assembly 34 is raised above the ground as illustrated at 52. The forklift assembly is provided with tines 54, which are kept parallel to the ground by an actuator 56 that angles the tines downwardly as the entire assembly is raised upwardly by chain 46.

Also important to note is that a pickup truck driver 56, because of his height above ground 52, has a sightline 58 that is quite high, as illustrated by double-ended arrow 60. It is noted that the sightline is clearly above the top 62 of the forklift assembly 34, thus to provide the operator with clear visibility, unlike the case in traditional forklift trucks.

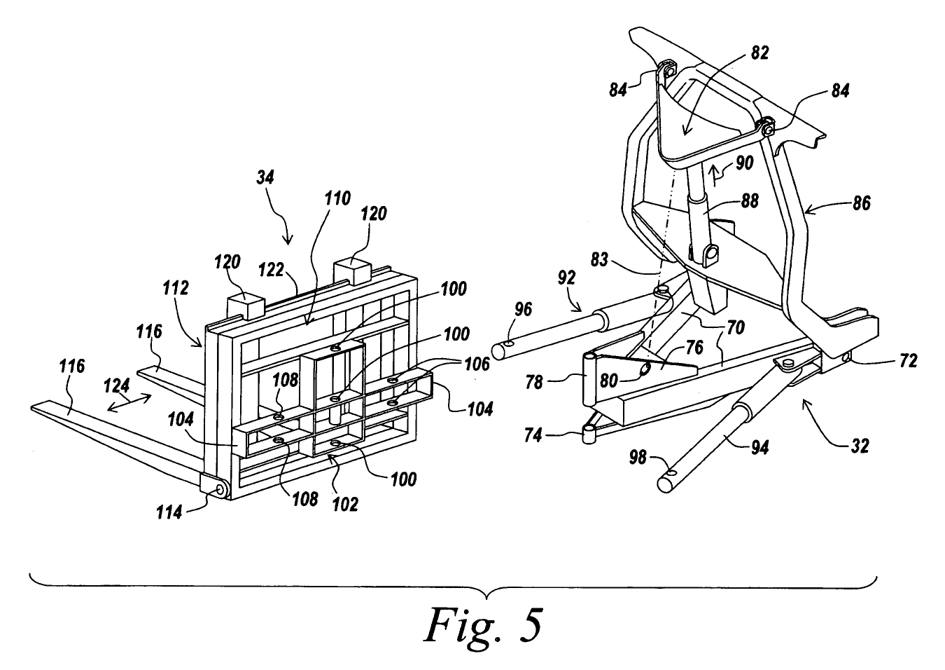

Referring to FIG. 5, a typical snowplow mount 32 is provided with a V-shaped frame 70 that is pivoted at pivot point 72 to the truck body. The distal end of frame 70 has a cylindrical pivot pin socket 74 positioned below a stabilizing assembly 76 mounted to frame 70. The stabilizing assembly, also V-shaped, provides a co-aligned socket 78, with both sockets adapted to receive a central locating pin. An orifice 80 located at stabilizer 76 is mechanically coupled to a lift assembly 82 as illustrated by dotted line 84. Lift assembly 82 is pivotally attached at 84 to a rigid frame assembly 86 attached to the body of the truck. An actuator 88, when extended in the direction of arrow 90, causes pivot assembly 82 to move upwardly, which tensions on line 84 lift frame 70 in an upward direction as it pivots around pivot point 72.

In this manner the entire front end of the plow mount is vertically lifted upon actuation of actuator 88 so that frame 70 pivots upwardly about pivot point 72.

Frame 70 also includes lateral actuators 92 and 94 that have respective orifices 96 and 98 at the distal ends thereof, which under ordinary use are adapted to receive the opposite sides of a snowplow to angle the snowplow with respect to the center line of the truck to which the snowplow mount is attached. The blade is normally pivoted about pin sockets 74 and 78 such that the blade may be swung or arced from left to right.

Rather than mounting a snowplow place on assembly 32, in the subject invention forklift assembly 34 is mounted to snowplow mount 32 through a pin that goes through orifices 100 in a subframe 102. Subframe 102 has a laterally-extending portion 104 to either side of these orifices. The laterally extending portion 104 is provided with orifices 106 and 108 to either side of the frame. These orifices are adapted to receive pins that go through the orifices and into respective orifices 96 and 98.

Sub-frame 102 has a fixed frame 110 welded thereto, with a pivoted frame 112 pivoted to frame 110 at pivot point 114.

Pivoted frame 112 is provided with forklift tines 116 hung on it, with the tines extending outwardly from pivoted frame 112.

As will be seen, pivoted frame 112 is provided to horizontally position the tines when the forklift assembly is moved upwardly. Note that tines 116 are hung on pivoted frame 112 by upstanding portions 120, having an upper portion that is notched and adapted to overlie a lip 122 of pivoted frame 112.

Thus the tines for the forklift may be carried in the bed of the truck and merely hung over lip 122 on subframe 112 in order to attach the tines to the pivoted frame. Note that the spacing between the tines 116 is adjustable by virtue of the point at which the tines are hung over lip 122, the positioning being illustrated by double-ended arrow 124.

It will be appreciated that if it is not desired to level the tines as the forklift assembly is lifted and pivoted about point 72 with the upward pivoting of the snowplow mount, then pivoted frame 112 may either be integral to frame 110 or clamped thereto.

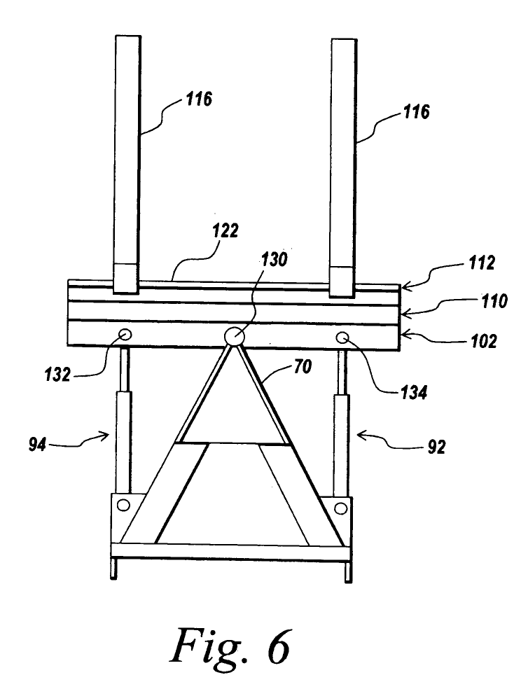

Referring to FIG. 6, what is diagrammatically shown is a top view of the completed assembly of FIG. 5, in which subframe 102 carrying fixed frame 110 and pivoted frame 112 is mounted to V-shaped frame 70 at central point 130 with a pin and at lateral points 132 and 134, also by pins.

Here it can be seen that tines 116 are hung over lip 122 of subframe 110 for easy mounting to the forklift assembly.

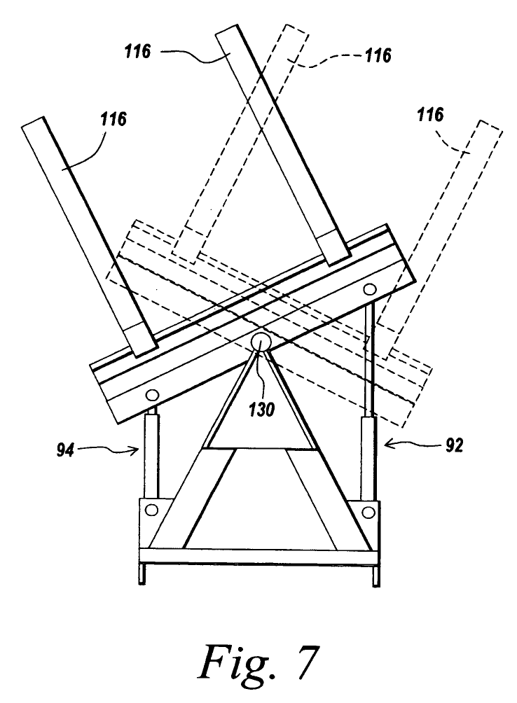

Referring now to FIG. 7, it can be seen that upon opposite actuation of actuators 92 and 94, the original orientation of tines 116 can be pivoted about pin 130 either to the left or to the right as illustrated in dotted outline.

This permits fine-tuning or adjustment of the tines just prior to the time that they engage a pallet or load. Thus if the truck cannot maneuver the tines directly by the maneuvering of the truck's front wheels, further adjustments may be made in the positioning of the tines prior to the pickup of a load.

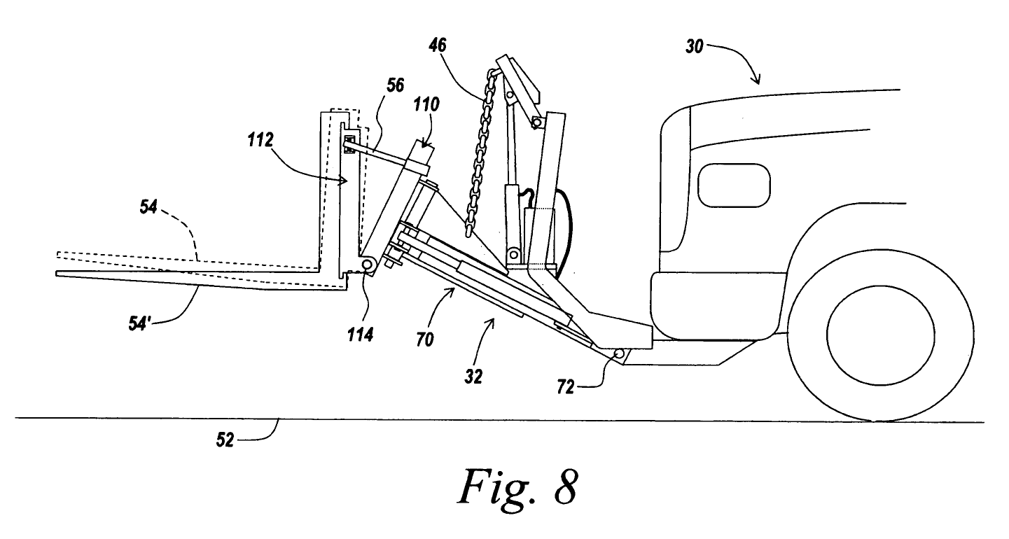

Referring now to FIG. 8, when snowplow mount 32 is raised by chain 46, tines 54 will be canted backwardly so that the tines are not parallel to ground 52. Actuator 56 can either automatically or manually be actuated to reposition tines 54 to a horizontal position as illustrated at 54′, thus to counteract the pivoting of snowplow mount 30 about point 72.

In this case, pivotable frame 112 is pivoted about fixed frame 110 about point 114 by actuator 56. This actuator may either be a lead screw or other type of actuator, either manually controlled at the cab of the truck or automatically controlled by the angle of frame 70 to ground 52.

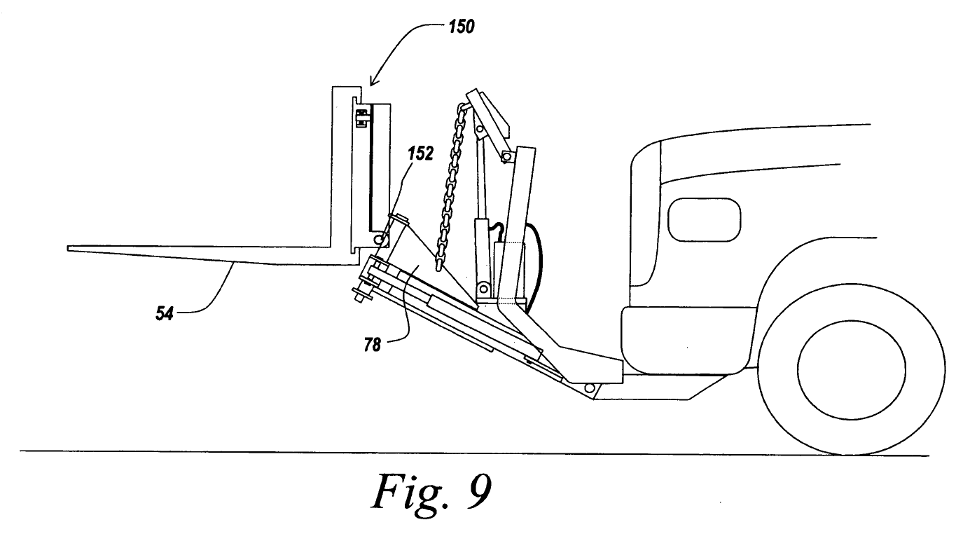

Alternatively, as illustrated in FIG. 9, the entire forklift frame, here illustrated at 150, may be itself automatically pivoted at point 152 about reinforcing frame 78 such that the entire frame on which the tines are hung is automatically pivoted.

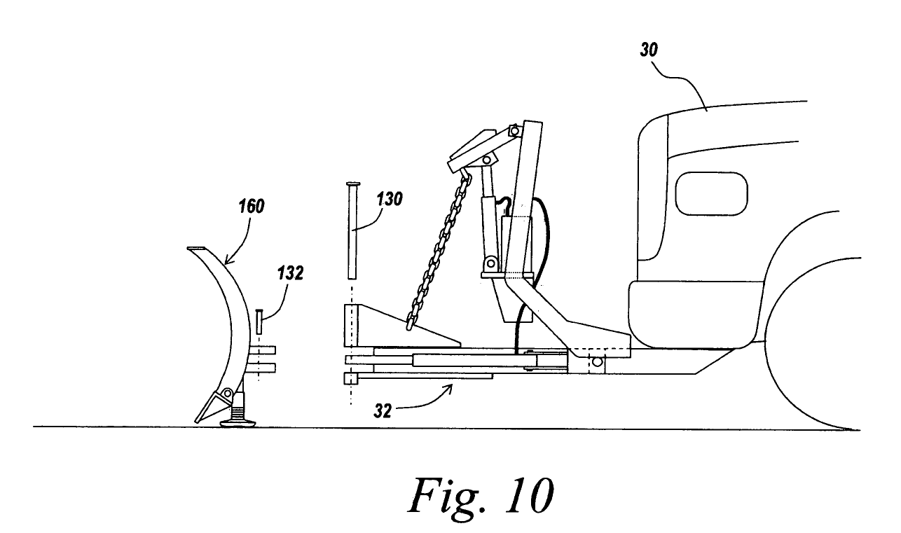

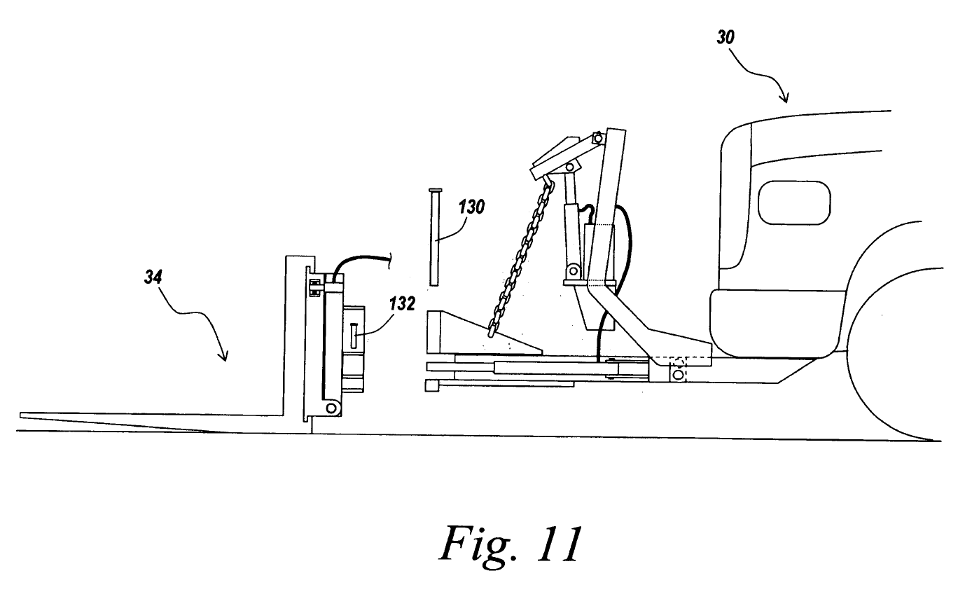

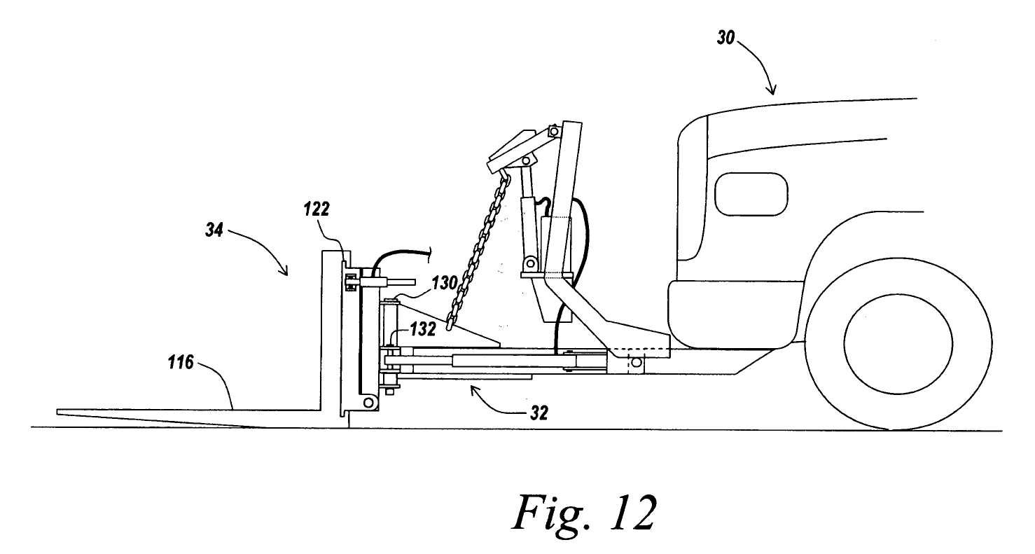

Referring now to FIG. 10, what can be seen is the ease by which a plow blade 160 can be removed from snowplow mount 32 by the removal of pins 130 and 132. Upon removal, truck 30 backs away, and as illustrated in FIG. 11, the forklift assembly 34 is positioned on the ground in front of the truck. Truck 30 then moves the snowplow mount towards the forklift assembly and pins 130 and 132 are slipped into respective sockets and orifices, such that as illustrated at FIG. 12, forklift assembly 34 is releasably attached to snowplow mount 32, whereupon it can be picked up by truck 30 and moved to any suitable location. Here it will be appreciated that assembly 34, with tines 116 hung on lip 122, can be conveniently placed anywhere on the ground, with truck 30 merely maneuvered to permit the mounting of the forklift assembly in place of the plow blade.

What will be therefore seen is that one can adapt a light truck, ubiquitous in today's society along with its ubiquitous snowplow mount, and adapt it for a completely different purpose, namely the supplying of forklift functionality to a jobsite.

It will be appreciated that the usual forklift attachments may be placed on the removable forklift, thus to be able to accommodate, for instance, oil drums and irregularly shaped articles.

Note also that there is no carriage rack to obscure vision as is common in traditional forklift trucks.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method to facilitate transport of a load within a jobsite, comprising the steps of:
locating a snowplow mount on a light truck; and,
attaching a forklift assembly having tines extending therefrom to the front of a snowplow mount, whereby the tines and the forklift assembly are transportable to the jobsite over a highway, and whereby the jobsite can be easily traversed regardless of terrain by the light truck such that loads can be picked up by the truck-mounted forklift assembly at one position at the jobsite and deposited at another position at the jobsite.

2. The method of claim 1, and further including the step of positioning the tines of the forklift assembly beneath a load by maneuvering the truck with the forklift assembly to a position adjacent the load, lowering the forklift assembly such that the tines are at ground level adjacent the load and maneuvering the truck forward to insert the tines underneath the load.

3. The method of claim 2, and further including the steps of angling the tines of the forklift assembly relative to the centerline of the truck by actuation of the snowplow mount, whereby the same mechanism used to position the snowplow blade is used to angle the tines of the forklift assembly.

4. The method of claim 1, and further including the steps of raising and lowering the tines of the forklift assembly using the mechanism provided by the snowplow mount for raising and lowering a snowplow when attached.

5. The method of claim 4, wherein the snowplow mount is pivotally attached to the light truck such that when the snowplow mount is lowered, the tines of the forklift assembly are angled downwardly, and further including the step of repositioning the tines of the forklift assembly to a horizontal position as the forklift assembly is raised by the raising of the snowplow mount that upwardly tilts the tines of the forklift assembly.

6. The method of claim 5, wherein the step of repositioning the tines to a horizontal position includes providing the forklift assembly with a pivotally mounted subframe and actuating the subframe to pivot relative to the forklift assembly to provide that, as the forklift assembly is raised, the tines of the forklift assembly are moved to a horizontal position.

7. The method of claim 6, wherein the repositioning of the tines includes the step of automatically moving the tines to a horizontal position responsive to the raising of the forklift assembly by the raising of the snowplow mount.

8. The method of claim 6, wherein the horizontal repositioning of the tines upon raising of the forklift assembly includes the step of manually actuating the subassembly.

9. The method of claim 7, wherein the step of repositioning the tines to a horizontal position includes an actuator coupled to the forklift assembly for repositioning the tines responsive to a sensed raise of the forklift assembly.

10. The method of claim 1, wherein the truck is provided with a four-wheel drive and sufficient clearance to permit maneuvering over uneven terrain at the jobsite.

11. In combination with a light truck having a snowplow mount, apparatus for the transport of loads from one location at a jobsite to another, comprising:
a forklift assembly having spaced-apart tines releasably attachable to said snowplow mount and moveable with said snowplow mount in an upward direction with the raising of the snowplow mount and in a downward direction when lowering the snowplow mount, whereby said forklift assembly can be lowered to ground level for insertion under a load and can be used to raise the load upon engagement of the tines of said forklift assembly upon the raising of the snowplow mount, said forklift assembly and tines being transportable along a highway to the jobsite and maneuvered by said truck over the jobsite terrain, with the maneuvering of the truck used to position the tines of the forklift assembly.

12. The apparatus of claim 11, wherein said forklift assembly includes a frame and wherein said tines are releasably attachable to said frame.

13. The apparatus of claim 12, wherein releasably attachable tines are adapted to be hung on said frame, said frame including a lip, each of said tines including a laterally extending tine portion and an upwardly extending member having a back surface adapted to co-act with said frame when said tines are hung on said frame.

14. The apparatus of claim 13, wherein each of said members includes a hook at the top thereof adapted to hook over said lip, whereby said tires are releasably attached to said frame by hooking said members over said lip.

15. The apparatus of claim 14, wherein the lateral spacing of said tines is determined by the position at which said members are hooked over said lip.

16. The apparatus of claim 12, and further including a subassembly pivotally attached to said frame and carrying said tines, said subassembly repositioning said tines to a horizontal position as said forklift assembly is raised by the raising of said snowplow mount.

17. The apparatus of claim 16, and further including an actuator coupled to said subassembly and said frame for positioning said subassembly with respect to said frame so as to reposition said tines.

18. The apparatus of claim 17, wherein said actuator is manually actuated.

19. The apparatus of claim 17, wherein said actuator is automatically actuated based upon the level to which said frame assembly is raised.

20. The apparatus of claim 11, wherein said snowplow mount includes lateral actuators for angularly positioning said snowplow mount and thus the tines of said forklift assembly relative to the centerline of said truck, said snowplow mount being pivotally mounted to said truck about a vertical axis and pivoted by the actuation of said lateral actuators.
